(19) United States
(12) Patent Application Publication
(10) Pub. No.: US 2014/0137446 A1
(43) Pub. Date: May 22, 2014

(54) MARKING APPARATUS FOR DISHWARE

(71) Applicants: Suzanne Monaghan, Fredericksburg, VA (US); Dennis K. Scheer, Birmingham, MI (US)

(72) Inventors: Suzanne Monaghan, Fredericksburg, VA (US); Dennis K. Scheer, Birmingham, MI (US)

(73) Assignee: Suzanne Monaghan, Fredericksburg, VA (US)

(21) Appl. No.: 14/066,652

(22) Filed: Oct. 29, 2013

Related U.S. Application Data
(63) Continuation-in-part of application No. 12/691,187, filed on Jan. 21, 2010.

(51) Int. Cl. G09F 3/18

(52) U.S. Cl. CPC G09F 3/18
USPC 40/324; 248/542

(57) ABSTRACT

A marking apparatus for a dishware is provided. The apparatus includes a base portion, a first support member extending from the base portion, and a second support member extending from the base portion opposite the first support member so as to define a cavity therebetween. At least one of the first support member and the second support member include at least one slot structured for retaining an indicium member received therein.

### CROSS REFERENCE TO RELATED APPLICATIONS

This continuation-in-part application claims the benefit of prior U.S. application Ser. No. 12/691,187, filed on Jan. 21, 2010, which claims the benefit of U.S. provisional application Ser. No. 61/146,006 filed on Jan. 21, 2009, the disclosure of which is incorporated by reference.

### FIELD OF THE DISCLOSURE

The present disclosure generally relates to a marking apparatus for a dishware.

### BACKGROUND OF THE INVENTION

Dishware, such as plates and trays, are used by various individuals at places such as restaurants, hotels and other establishments, for serving and/ or consuming a variety of food products. Generally, in restaurants and other establishments, the food products are prepared by cooks or chefs, and are served by waiters to consumers. These food products may include various ingredients, such as gluten, dairy products, fish products, egg products and the like. Few of these ingredients may act as allergens for certain individuals.

However, some of these ingredients may act as allergens for certain individuals. That is, certain consumers may have an allergy or sensitivity to certain ingredients that may be contained in or used in preparing the food products. Accordingly, such consumers wish to be served with a food product that is free from such allergens. However, it may be difficult for a consumer to receive a food product which is free from an allergen, when eating at a public place. Moreover, it also becomes difficult for chefs and waiters to be sure that the food product being served to the consumer is free from the allergen.

### SUMMARY OF THE INVENTION

In one aspect of the embodiments described herein, a marking apparatus for a dishware is provided. The apparatus includes a base portion, a first support member extending from the base portion, and a second support member extending from the base portion opposite the first support member so as to define a cavity therebetween. At least one of the first support member and the second support member include at least one slot structured for retaining an indicium member received therein.

In another aspect of the embodiments described herein, a marking apparatus for a dishware is provided. The marking apparatus includes a base portion and a first support member extending from the base portion. The first support member has a first surface area. A second support member also extends from the base portion. The second support member has a second surface area. The second surface area is greater than the first surface area.

In another aspect of the embodiments described herein, an apparatus is provided for indicating a feature of a food item located on a food serving implement to which the apparatus is attached. The apparatus includes a base portion and a support member extending from the base portion. At least one slot is located on the support member. An indicium member is removably positioned in the at least one slot. The indicium member includes an indicium denoting the feature of the food item.

### BRIEF DESCRIPTION OF THE DRAWINGS

These and other features and advantages of the present disclosure will be apparent from the following detailed description of preferred embodiments and best mode, appended claims, and accompanying drawings in which:

FIG. 1 is a perspective view of one embodiment of a marking apparatus;

FIG. 2 is a perspective view of the marking apparatus of FIG. 1, attached to a dishware;

FIG. 3 depicts an alternate embodiment of a marking apparatus; and,

FIG. 4 depicts another alternate embodiment of a marking apparatus.

FIG. 5 is a perspective view of another alternate embodiment of a marking apparatus.

FIG. 6 is a rear view of the marking apparatus embodiment shown in FIG. 5.

FIG. 7 is a front view of the marking apparatus embodiment shown in FIG. 5.

FIG. 8 shows several examples of representative indicium members usable in the embodiments described herein.

FIG. 9 is a perspective view of another alternate embodiment of a marking apparatus.

FIG. 9A is another perspective view of the embodiment of a marking apparatus shown in FIG. 9.

FIG. 10 is a rear view of the marking apparatus embodiment shown in FIG. 9.

FIG. 11 is a front view of the marking apparatus embodiment shown in FIG. 9.

FIG. 12 is a perspective view of an embodiment of the marking apparatus holding a document within a document-retaining slot incorporated into the marking apparatus.

FIG. 13 is a perspective view of another alternate embodiment of a marking apparatus.

FIG. 14 is a rear view of the marking apparatus embodiment shown in FIG. 13.

FIG. 15 is a front view of the marking apparatus embodiment shown in FIG. 13.

FIG. 16 is a cross-sectional side view of another embodiment of a marking apparatus.

FIGS. 16-21 are plan views of different embodiments of a first support member usable in associated embodiments of a marking apparatus.

FIG. 22 is a cross-sectional side view of another embodiment of a marking apparatus.

FIG. 23 is a plan view showing an arrangement of indicium member-receiving slots formed in a first support member, in accordance with one embodiment described herein.

FIG. 24 is a plan view showing an arrangement of indicium member-receiving slots formed in a first support member, in accordance with another embodiment described herein.

FIG. 25 is a plan view showing an arrangement of indicium member-receiving slots formed in a first support member, in accordance with another embodiment described herein.

FIG. 26 is a partial cross-sectional view of an indicium member-receiving slot in accordance with an embodiment described herein.

FIG. 27 is a partial cross-sectional view of an indicium member-receiving slot in accordance with another embodiment described herein.

FIG. 28 is a plan view of an indicium member-receiving slot formed in a first support member, in accordance with another embodiment described herein.

FIG. 29 is a plan view showing an arrangement of indicium member-receiving slots formed in a first support member, in accordance with another embodiment described herein.

FIG. 30 is a plan view showing an arrangement of indicium member-receiving slots formed in a first support member, in accordance with another embodiment described herein.

### DETAILED DESCRIPTION

The exemplary embodiments described herein in detail for illustrative purposes are subject to many variations in structure and design. It should be emphasized, however, that the present disclosure is not limited to a particular marking apparatus, as shown and described. It is understood that various omissions and substitutions of equivalents are contemplated as circumstances may suggest or render expedient, but these are intended to cover the application or embodiment without departing from the spirit or scope of the claims of the present disclosure. Also, it is to be understood that the phraseology and terminology used herein are for the purpose of description and should not be regarded as limiting.

The use of “including,” “comprising,” or “having” and variations thereof herein is meant to encompass the items listed thereafter and equivalents thereof as well as additional items. The terms such as “first” and “second” and other variations thereof as used herein, do not denote an order, elevation or importance, but rather used signify the presence of at least one of the referenced item. Further, the terms, “a” and “an” herein do not denote a limitation of quantity, but rather denote the presence of at least one of the referenced item.

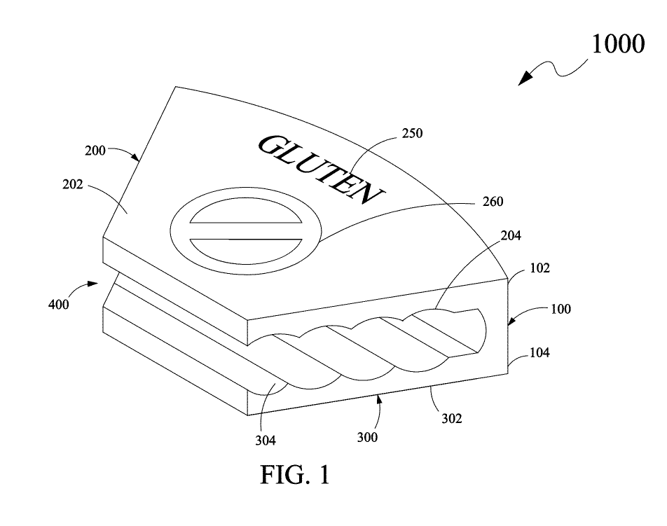

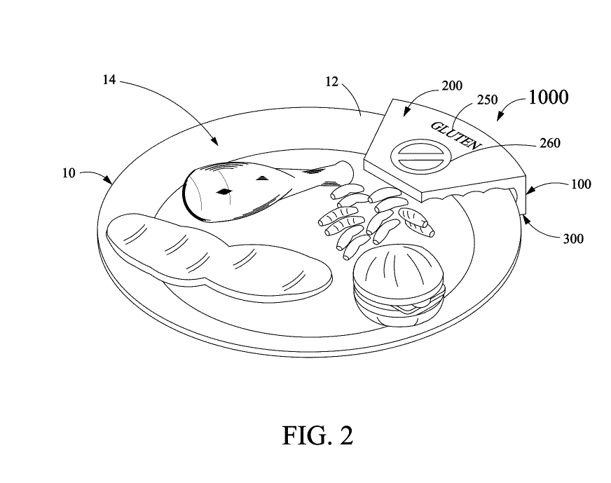

Referring to FIGS. 1-2, one embodiment of a marking apparatus 1000, which may be used for marking a dishware 10 is shown. The dishware 10 may be a plate. In another form, the dishware 10 may be either a tray or any form of a dishware used for serving and/ or consuming any food product.

The marking apparatus 1000 may include a central member 100 having a first peripheral edge portion 102 and a second peripheral edge portion 104 opposite to the first peripheral edge portion 102. The central member 100 may be conformed according to a peripheral portion 12 of the dishware 10 (as shown in FIG. 2). The central member 100 may be composed of a heat-resistant material. The central member 100 may be formed from a “dishwasher-safe” material. As used herein, the term “dishwasher-safe” is understood to mean that any color, text, image, or combination thereof imparted to the material will not wear off or wash off to any appreciable degree as a result of cycling the material through a dishwasher. The central member 100 may be formed from a rubber material. Of course, the central member 100 may instead be manufactured from any other suitable material without departing from the scope of the present disclosure. In addition, the central member 100 may be configured to have a variety of colors, such as red, blue or green, or combinations thereof.

The marking apparatus 1000 may further include a first support member 200. The first support member 200 may extend outwardly from the first peripheral edge portion 102 of the central member 100. The first support member 200 may include an outer surface 202 and a toothed inner surface 204.

The outer surface 202 of the first support member 200 may include at least one indicium displayed thereon. As used herein, the term “indicium” is understood to denote a sign or something that serves to indicate. The at least one indicium may include a text message 250. The text message 250 may correspond to a food product 14 carried by the dishware 10. The text message 250 may indicate the absence of an ingredient, such as gluten, diary and the like, in the food product 14 carried by the dishware 10. Such an ingredient may be an allergen for a consumer of the food product 14. For example, the text message 250 may state “GLUTEN” to indicate that the food product 14 may be free from gluten and is specific for a person who is allergic to gluten. In another form, the text message 250 may indicate the presence of the ingredient in the food product 14 carried by the dishware 10.

The at least one indicium may also optionally include an image 260. The image 260 may correspond to a food product or an ingredient in the food product 14 carried by the dishware 10. For example, the image 260 may indicate the presence of the ingredient, such as gluten, diary and the like, in the food product 14 carried by the dishware 10. This may be useful in instances where, for example, a type of food product contains a potential allergen that a consumer may normally assume would not be present in the food product. The allergen may be present because of the way the food product was prepared or may reside in an additive applied to the food product, for example. In another form, the image 260 may indicate the absence of the ingredient in the food product 14 carried by the dishware 10. The food product 14 may include one or more food items.

Alternatively, the at least one indicium may include both text and an image which combine to indicate the presence or absence of a food product or an ingredient of a food product.

In the embodiment shown in FIGS. 1 and 2, the text 250 indicates the type of potential allergen while the symbol or image 260 (or lack thereof) indicates the presence (or absence) of the potential allergen. That is, when the image 260 is present, the message conveyed to the consumer is that the type of potential allergen indicated by the text 250 is not present in the food product carried by the dishware 10 (or in food products intended to be carried by the dishware). Similarly, when the image 260 is absent, the message conveyed to the consumer is that the type of potential allergen indicated by the text 250 is (or may be) present in the food product carried by the dishware 10 (or in food products intended to be carried by the dishware).

For the purpose of the description, the dishware 10 is shown to carry the food product 14, however the dishware 10 may also be marked prior to carrying any food product. Accordingly, the text message 250 and/ or the image 260 may correspond to a food product (not shown), which is intended to be carried by the dishware 10. The text message 250 and/ or the image 260 may indicate the absence of an ingredient in the food product intended to be carried by the dishware 10. The ingredient may be an allergen to a consumer of the food product intended to be carried by the dishware 10. In another form, the text message 250 and/ or the image 260 may indicate the presence of the ingredient in the food product intended to be carried by the dishware 10.

The toothed inner surface 204 of the first support member 200 may be capable of gripping and securing to the peripheral portion 12 of the dishware 10, thereby attaching the marking apparatus 1000 to the dishware 10.

The first support member 200 may be formed from a heat-resistant material. The first support member 200 may be formed from a “dishwasher-safe” material. As used herein, the term “dishwasher-safe” is understood to mean that any color, text, image, or combination thereof imparted to the material will not wear off or wash off to any appreciable degree as a result of cycling the material through a dishwasher. The first support member 200 may be formed from a rubber material. Alternatively, the first support member 200 may be formed from another material specified so as to provide frictional engagement with the dishware to aid in retaining the marking apparatus 1000 to the dishware. Of course, the first support member 200 may instead be manufactured from any other suitable material without departing from the scope of the present disclosure. In addition, the first support member 200 may be configured to have any of a variety of colors, such as red, blue or green, or combinations thereof, which may be similar to the color of the central member 100.

Further, the marking apparatus 1000 may include a second support member 300. The second support member 300 may extend outwardly from the second peripheral edge portion 104 of the central member 100. The second support member 300 may include an outer surface 302 and a toothed inner surface 304.

The outer surface 302 of the second support member 300 may optionally include at least one indicium (not shown) displayed thereon. The at least one indicium may include a text message, which may be similar to the text message 250. The text message may correspond to the food product 14 or to an ingredient of the food product carried by the dishware 10. The text message may alternatively correspond to the food product or to an ingredient of the food product intended to be carried by the dishware 10. Further, the outer surface 302 may include an image (not shown), which may be similar to the image 260. In another form, the outer surface 302 may include at least one indicium for the food product or an ingredient of the food product intended to be carried by the dishware 10. Optionally, the outer surface may include an image, text, or combination thereof indicating the name of a restaurant or other location where the food product is served.

The toothed inner surface 304 of the second support member 300 may be capable of securing and gripping to the peripheral portion 12 of the dishware 10, thereby attaching the marking apparatus 1000 to the dishware 10.

The second support member 300 may be formed from a heat-resistant material. The second support member 300 may be formed from a “dishwasher-safe” material. As used herein, the term “dishwasher-safe” is understood to mean that any color, text, image, or combination thereof imparted to the material will not wear off or wash off to any appreciable degree as a result of cycling the material through a dishwasher. The second support member 300 may be formed from a rubber material. Alternatively, the second support member 300 may be formed from another material specified so as to provide frictional engagement with the dishware to aid in retaining the marking apparatus 1000 to the dishware. Of course, the second support member 300 may instead be manufactured from any other suitable material without departing from the scope of the present disclosure. In addition, the second support member 300 may be configured to have any of a variety of colors, such as red, blue or green, or combinations thereof, which may be similar to the color of the central member 100 and/ or the first support member 200.

As best shown in FIG. 1, the first support member 200 and the second support member 300 configure a slot 400 therebetween. The slot 400 may be adapted to receive the peripheral portion 12 of the dishware 10 (as shown in FIG. 2). The toothed inner surfaces 204 and 304 may be capable of gripping and securing to the peripheral portion 12 of the dishware 10 thereby attaching the marking apparatus 1000 to the dishware 10. The marking apparatus 1000 upon being attached to the dishware 10 enables in marking the dishware 10 to signify either the presence or the absence of the ingredient from the food product 14 that may be carried by the dishware 10 or the food product intended to be carried by the dishware 10.

In embodiments disclosed herein, any of a variety of words, symbols, other indicia or suitable combinations thereof may be positioned on the marking apparatus 1000 to convey the presence or absence of any of a variety of food products or ingredients or other substances contained in the food products carried on the dishware. For example, only text may be used to indicate the absence or presence of the food product or food product ingredient. Alternatively, only one or more symbols or images may be used to indicate the absence or presence of the food product or food product ingredient. Alternatively, as previously described, a combination of suitable text and symbols may be used to indicate the absence or presence of the food product or food product ingredient. Any text, symbols or images, or combinations thereof suitable for conveying the desired message may be used.

In another alternative embodiment, either text alone, one or more images alone, or a combination of text and images are used to denote multiple separate and different features of the food product rather than a single feature (for example, the presence or absence of a potential allergen).

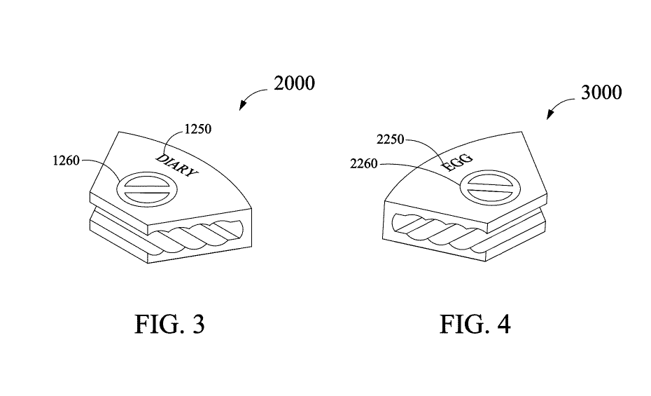

FIG. 3 and FIG. 4 depict alternative embodiments of a marking apparatus for a dishware. Specifically, FIG. 3 shows a marking apparatus 2000 and FIG. 4 shows a marking apparatus 3000. The marking apparatus 2000, and the marking apparatus 3000 may be structurally and functionally similar to the marking apparatus 1000, therefore for the sake of brevity, the description of the same has been omitted. However, the marking apparatus 2000 may include a text message 1250, which states “DAIRY,” and an image 1260, which, taken in conjunction with the text message 1250, indicates “NO DAIRY”. Similarly, the marking apparatus 3000 may include a text message 2250, which indicates “NUTS,” and an image 2260, which, taken in conjunction with the text message 2250, indicates “NO NUTS”. Alternatively, as previously described, any desired image (or images), text, or combination thereof may be arranged on the marking apparatus 2000 to indicate the absence or presence of potential allergens such as eggs, dairy products, or gluten.

In use, the peripheral portion 12 of the dishware 10 may be received in the slot 400 of the marking apparatus 1000, such that the peripheral portion 12 gets attached to the first support member 200 and the second support member 300, thereby attaching the marking apparatus 1000 to the dishware 10. The at least one indicium on the marking apparatus 1000 may correspond to the food product 14 carried by the dishware 10. The at least one indicium may be or include the text message 250. Further, the at least one indicium may be or include the image 260. More specifically, the text message 250 or the image 260 may indicate the absence of “GLUTEN” from the food product 14 carried by the dishware 10. Accordingly, the marking apparatus 1000 upon being attached to the dishware 10 enables an individual, such as a restaurant operator, a waiter, or a consumer of the food product 14, to be informed that the food product 14 prepared by a chef, lacks gluten or that any other food product containing gluten should be precluded from being carried by the dishware 10.

Accordingly, the marking apparatus 1000 provides the consumer a convenient way of marking the dishware 10 for communicating their food preferences of being served with a food product free from (or contains) a certain ingredient. Also, the marking apparatus 1000 provides restaurant operators, waiters, and chefs a convenient way of marking a dishware 10 for communicating that a food product contained in the dishware 10 is free from (or contains) a certain ingredient.

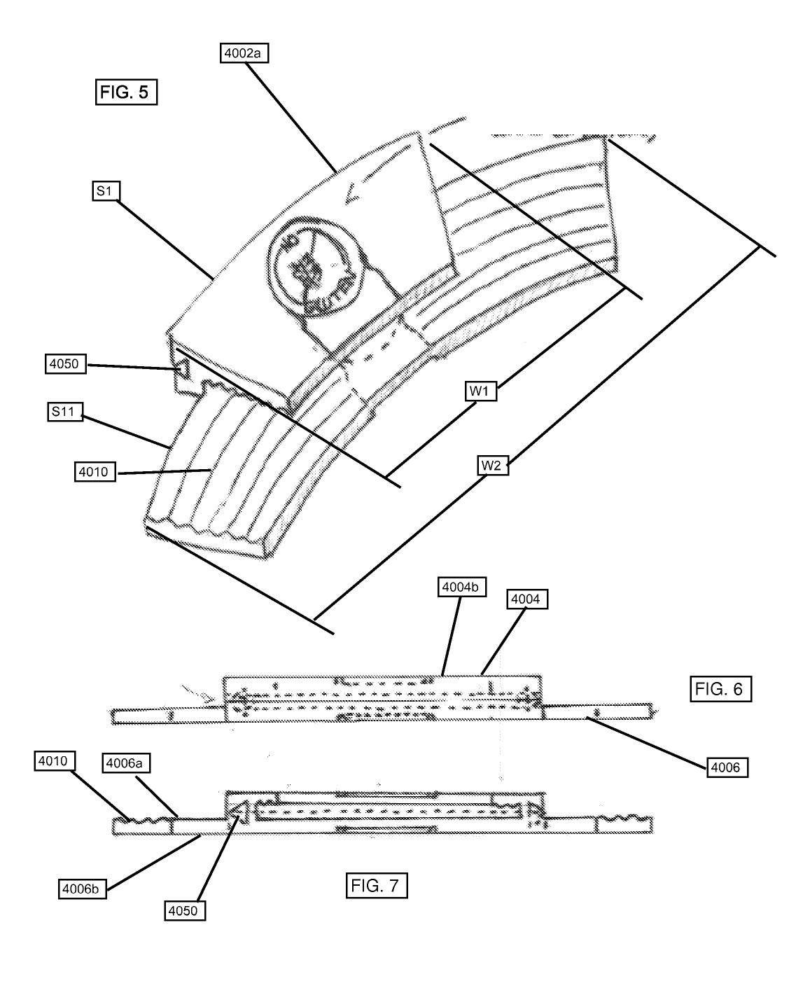

FIGS. 5-30 show other embodiments of the marking apparatus.

In the embodiments shown in FIGS. 5-30, marking apparatus 4000 has a base portion 4002, a first support member 4004 extending in a first direction from the base portion, and a second support member 4006 also extending in the first direction from the base portion. Base portion 4002 and first and second support members 4004 and 4006 combine to form a cavity 4008 structured to receive an edge of a piece of dishware 10, a tray or other food serving device.

First and second support members 4004 and 4006 are attached to base portion 4002 so as to be resiliently deflectable responsive to insertion of the dishware 10 between the support members and into the cavity. Thus, when the dishware is positioned between the first and second support members 4004 and 4006, the support members exert a gripping force on the dishware to retain the marking apparatus on the dishware.

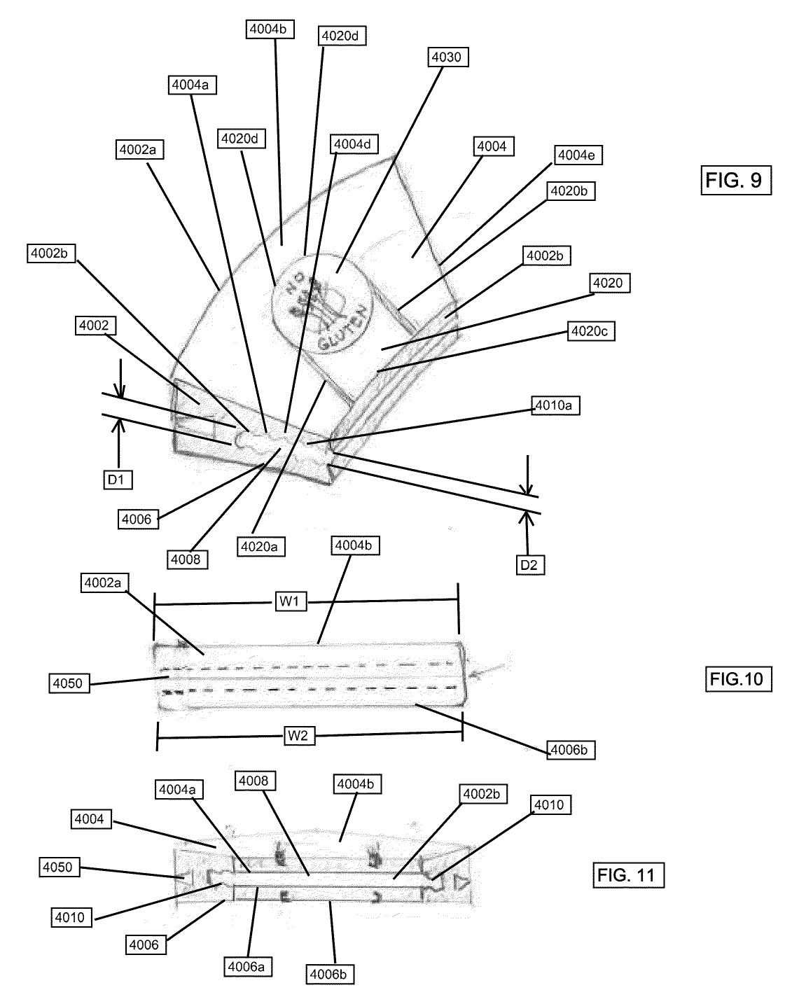

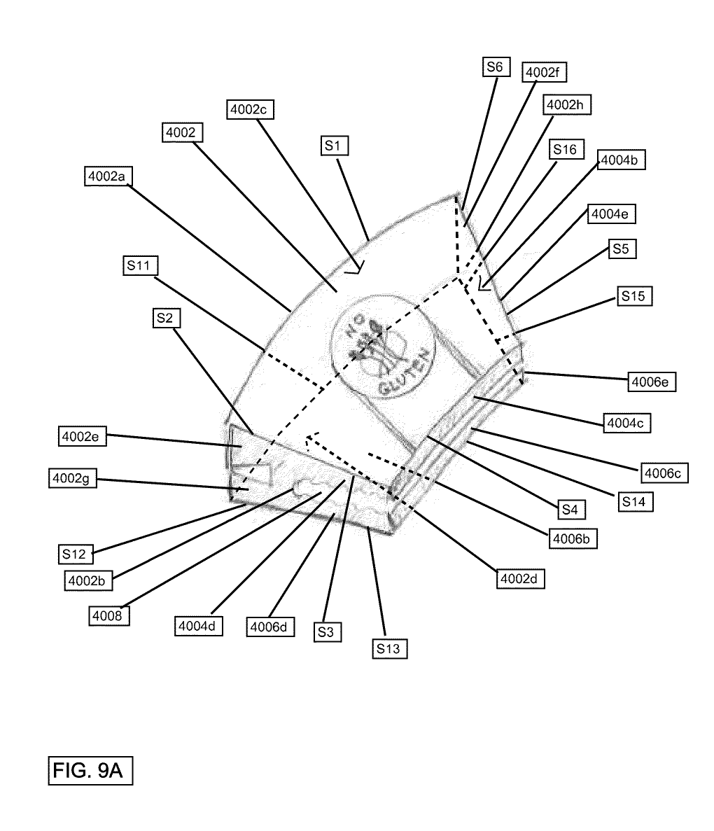

Referring to FIG. 9, in a particular embodiment, a first dimension D1 of the cavity 4008 adjacent base portion 4002 is specified so as to be larger than the thicknesses of the edges of most or all conventional restaurant serving plates. In addition, a second dimension D2 of the cavity at the cavity opening 4008a is specified so as to be smaller than the thicknesses of the edges of most or all conventional restaurant serving plates. These dimensions help ensure that one or more of first and second support members 4004 and 4006 will be forced to deflect responsive to insertion of a plate edge into the cavity. This deflection results in a reactive retention or gripping force being applied to the dishware edge to help retain the marking apparatus on the dishware.

One or more of base portion 4002, first support member 4004 and second support member 4006 may be formed separately and then suitably attached to the remaining one or more of the base portion 4002, first support member 4004 and second support member 4006 to form marking apparatus 4000. Alternatively, base portion 4002, first support member 4004 and second support member 4006 may be formed as a single piece, for example by molding.

Referring to FIG. 9A, in the embodiments described herein, base portion 4002 has an outer edge 4002a and an inner edge 4002b positioned opposite outer edge 4002a. Inner edge 4002b is located within (and defines a portion of) cavity 4008. In the embodiments shown in FIGS. 5, 9, 12, 13, 17, 18 and 19, outer edge 4002a is curved. In alternative embodiments (not shown, for example, as shown in FIGS. 20 and 21), outer edge 4002a is straight or flat.

Base portion 4002 also has an upper face 4002c and a pair of upper face side edges 4002e and 4002f. In the embodiments shown, upper face 4002c intersects, joins, or merges with first support member outer face 4004b, upper face side edge 4002e intersects, joins, or merges with first support member side edge 4004d, and upper face side edge 4002f intersects, joins, or merges with first support member side edge 4004e.

Base portion 4002 also has a lower face 4002d and a pair of lower face side edges 4002g and 4002h. In the embodiments shown, lower face 4002d intersects, joins, or merges with second support member outer face 4006b, lower face side edge 4002g intersects, joins, or merges with second support member side edge 4006d, and lower face side edge 4002h intersects, joins, or merges with second support member side edge 4006e.

Inner edge 4002b may be dimensioned to generally conform to the curvature of an outer edge or perimeter of a dishware to which the marking apparatus is attached. In a particular embodiment, the inner edge 4002b has a radius of 10 inches. However, the inner edge may have a different curvature or may be formed as a straight edge, depending on the configuration of the device to which the marking apparatus is to be attached. In alternative embodiments (not shown), inner edge 4002b may be straight or flat to bear against a straight side of a serving tray, for example.

First support member 4004 has an inner face 4004a, an outer face 4004b, and an end edge 4004c formed opposite base portion outer edge 4002a, and opposed side edges 4004d and 4004e extending between the inner & outer faces. In particular embodiments (for example, as shown in FIGS. 18 and 21), end edge 4004c is straight. In other embodiments, end edge 4004c is curved. In the embodiments described herein, first support member 4004 is structured to contact the dishware 10 along an edge of a top or upper surface of the dishware, adjacent where food is positioned on the dishware.

In particular embodiments (as shown, for example, in FIGS. 5, 9, 12, 13 and 18-20), opposed side edges 4004d and 4004e are structured so that, if extended, they would converge. In other particular embodiments (as shown, for example, in FIGS. 17 and 21), opposed side edges 4004d and 4004e are structured to extend parallel with each other. FIGS. 17-21 show various examples of possible first support member shapes. Other alternative shapes may also be used depending on the requirements of a particular application.

Inner face 4004a is structured to contact a surface of a dishware inserted into cavity 4008 and to aid in retaining the inserted portion of the dishware within the cavity. To this end, inner face 4004a may have formed therealong a series of spaced-apart teeth or ridges 4010 structured to contact the dishware surface as previously described herein. In the embodiment shown, teeth 4010 extend between side edges 4004d and 4004e. However, the teeth may extend only part of the distance between the opposite side edges. In one embodiment, teeth 4010 are curved and spaced substantially equally apart, and have radii which decrease in a direction A proceeding from base portion outer edge 4002a. In another embodiment, the teeth 4010 are straight as shown and previously described with regard to toothed inner surface 304 of FIG. 1.

Referring to FIG. 9A, in the embodiments shown, a line S1 is defined by the intersection of base portion outer edge 4002a with base portion upper face 4002c. A line S2 is defined by the intersection of upper face side edge 4002e and base portion upper face 4002c. A line S3 is defined by the intersection of first support member side edge 4004d and outer face 4004b. A line S4 is defined by the intersection of first support member end edge 4004c and outer face 4004b, without a slot 4020 formed in the first support member outer face 4004b. A line S5 is defined by the intersection of first support member side edge 4004e and outer face 4004b. A line S6 is defined by the intersection of upper face side edge 4002e and upper face 4002c. Then, an upper surface area A1 of the marking apparatus is defined by a plane bounded by lines S1-S6.

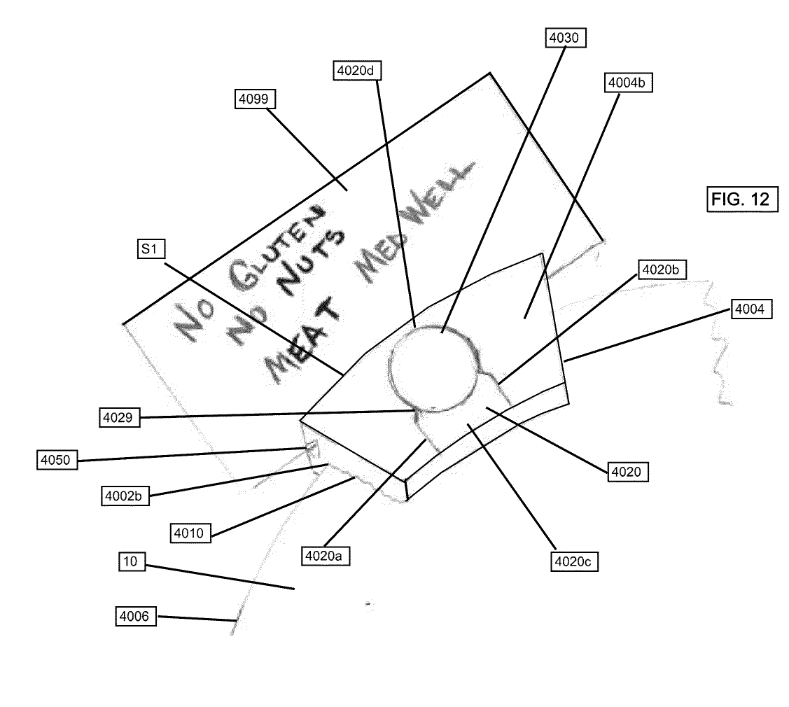

Second support member 4006 has an inner face 4006a, an outer face 4006b, and an end edge 4006c positioned opposite base portion outer edge 4002a, and opposed side edges 4006d and 4006e extending between the inner & outer faces. In particular embodiments, end edge 4006c is straight. In other embodiments, end edge 4006c is curved. In the embodiments described herein, second support member 4006 is structured to contact the dishware along a lower surface of the dishware, opposite the upper surface, as shown in FIG. 12 and as previously described with respect to FIGS. 1-4.

Referring to FIG. 9A, in the embodiments shown, a line S11 is defined by the intersection of base portion outer edge 4002a with base portion lower face 4002d. A line S12 is defined by the intersection of lower face side edge 4002g and base portion lower face 4002d. A line S13 is defined by the intersection of second support member side edge 4006d and second support member outer face 4006b. A line S14 is defined by the intersection of second support member end edge 4006c and second support member outer face 4006b, without a slot 4020 formed in the second support member outer face 4006b. A line S15 is defined by the intersection of second support member side edge 4006e and outer face 4006b. A line S16 is defined by the intersection of lower face side edge 4002g and upper lower 4002d. Then, a lower surface area A2 of the marking apparatus is defined by a plane bounded by lines S11-S16.

Inner face 4006a is structured to contact a surface of a dishware inserted into cavity 4008 and to aid in retaining the inserted portion of the dishware within the cavity. To this end, inner face 4006a may have formed therealong a series of spaced-apart teeth or ridges 4010 structured to contact the dishware surface as previously described herein. In the embodiment shown, teeth 4010 extend between side edges 4006d and 4006e. However, the teeth may extend only part of the distance between the opposite side edges. In one embodiment, teeth 4010 are curved and spaced substantially equally apart, having radii which decrease in a direction A proceeding from base portion outer edge 4002a. In another embodiment, the teeth 4010 are straight as shown and previously described with regard to toothed inner surface 304 of FIG. 1.

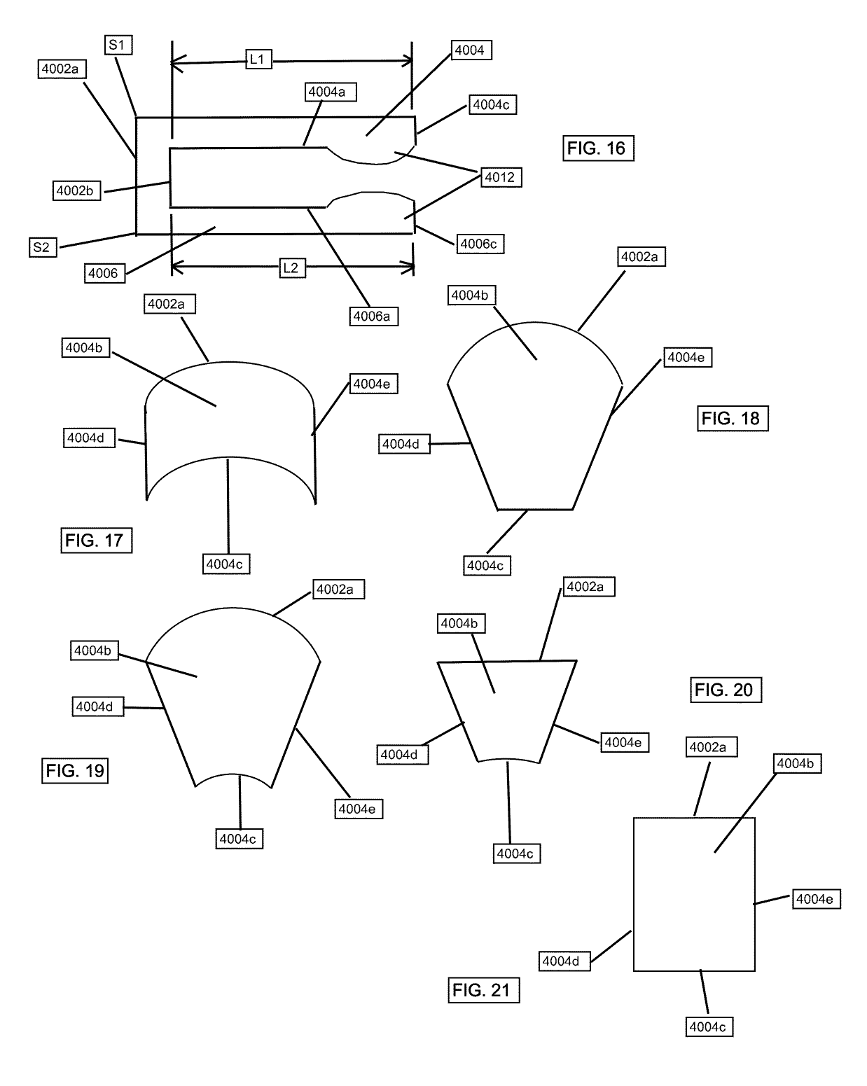

Referring to FIG. 16, in another embodiment, one or more rounded contact surfaces 4012 are formed along one or more of first support member inner face 4004a and second support member inner face 4006a. Because surfaces 4012 are rounded, it is believed that a portion of these surfaces will engage a surface of the dishware edge regardless of the thickness of the dishware edge, when dimension D1 of cavity 4008 is less than or equal to the thickness of the dishware edge.

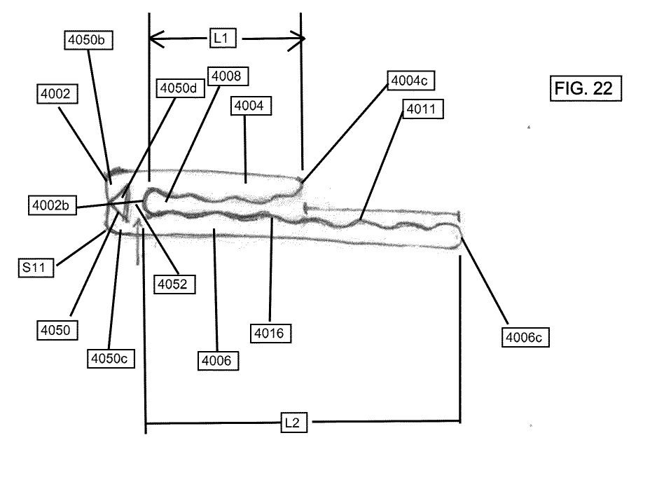

The teeth 4010 shown in FIG. 9 have pointed ends 4010a. Referring to FIG. 22, in yet another embodiment, teeth or ridges 4016 are formed having rounded ends 4011, to facilitate gripping of the dishware edge.

In the embodiment shown in FIG. 9, first support member 4004 and second support member 4006 have the same size and shape.

For the embodiments described herein, a width dimension W1 of the first support member is defined by a straight line extending between the endpoints of line S1. Also, a width dimension W2 of the second support member is defined by a straight line extending between the endpoints of line S11.

In other embodiments (for example, in the embodiments shown in FIG. 5), a width dimension W2 of the second support member 4006 extends along a first axis extending perpendicular to a second axis, where the second axis passes through the center of a circular plate or piece of dishware and extends radially from the center.

The second support member 4006 is structured to contact the dishware lower surface. In this embodiment, the width dimension W2 of the second support member 4006 is greater than a width W1 dimension of the first support member 4004 structured to contact the dishware upper surface. The first support member 4004 provides a relatively smaller surface area for contact with the server's thumb. The relatively larger second support member 4006 provides a relatively greater surface area for the remaining fingers of a server to contact and support the underside of the dishware, in case the dishware is too hot for the bare hand of the server.

As seen in FIGS. 16 and 22, a length dimension L1 of first support member 4004 is the distance from base portion inner edge 4002b to end edge 4004c of the first support member. Also as seen in FIGS. 16 and 22, a length dimension L2 of second support member 4006 is the distance from base portion inner edge 4002b to end edge 4006c of the second support member.

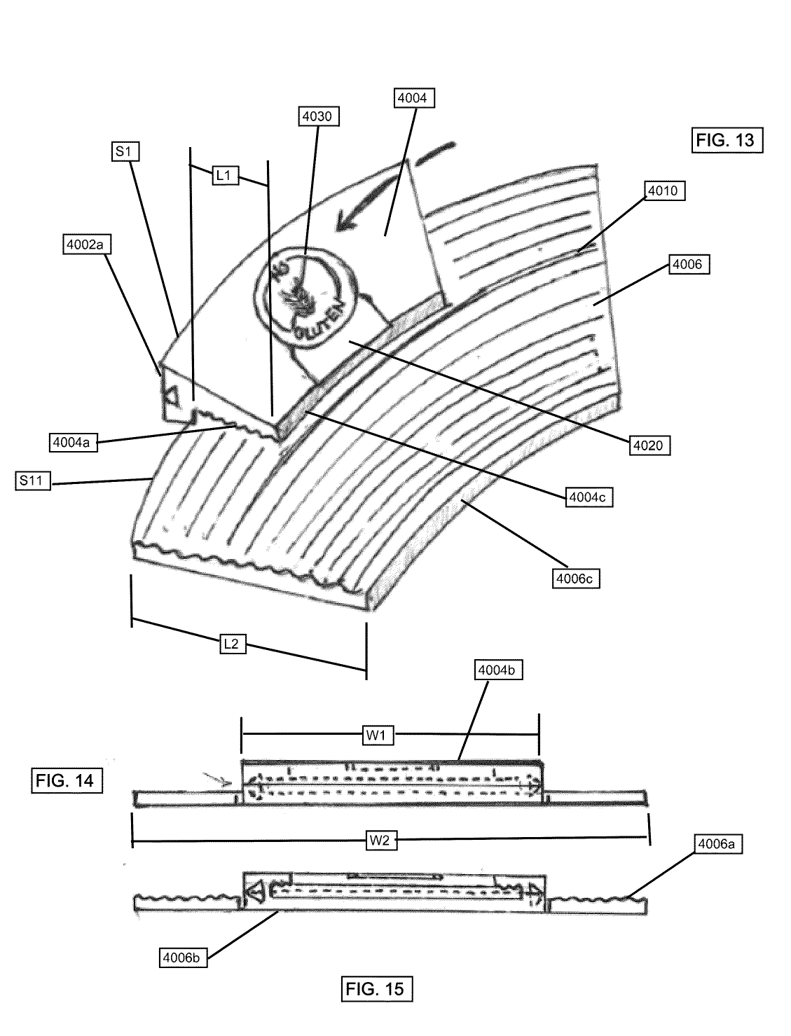

In other embodiments (for example, as shown in FIGS. 13 and 22, a length dimension L2 of the second support member 4006 (along a radially-extending axis passing through the center of a circular plate or piece of dishware) is relatively greater than a length dimension L1 of the first support member 4004. This permits the fingers supporting the dishware from the underside to extend relatively farther radially inwardly than the thumb on the first support member 4004 without the need to contact the dishware with bare fingers, thereby aiding the server in supporting the dishware. In a particular embodiment, L1 is 1.5 inches and L2 is 3 inches.

In a particular embodiment, the length dimension L2 of the second support member 4006 is relatively greater than the length dimension L1 of the first support member 4004, and the width dimension W2 of the second support member 4006 is relatively greater than the width dimension W1 of the first support member 4004. This provides additional space on the second support member 4006 to accommodate the server's fingers and for storage of indicium members if desired, as described below.

Referring now to the drawings, and specifically to FIGS. 9, 12 and 13 for purposes of discussion, each of the marking apparatus embodiments described herein incorporates at least one slot, generally designated 4020, structured for receiving and retaining therein an indicium member 4030, as described below. FIGS. 9, 12 and 13 show exemplary embodiments of slots usable in the marking apparatus embodiments described herein. However, alternative structures may be used.

Slot 4020 is structured with respect to the indicium member 4030 to retain the indicium member 4030 within the slot and to prevent removal of the indicium member from the slot until the member is manually or otherwise intentionally removed from the slot. In one embodiment, slot 4020 is formed as a depression in first support member outer face 4004b, so that an indicium member positioned in the slot will be clearly visible to a server and/or a customer viewing and/or handling the dishware.

Slot 4020 includes a pair of opposed walls 4020a and 4020b spaced apart such that an interference fit is formed between the walls and an indicium member 4030 inserted between the walls. Slot 4020 also includes an open end 4020c and an end wall 4020d defining a closed end opposite the open end. The indicium member 4030 is inserted into open end 4020c and pushed toward wall 4020d until the member bears against wall 4020d.

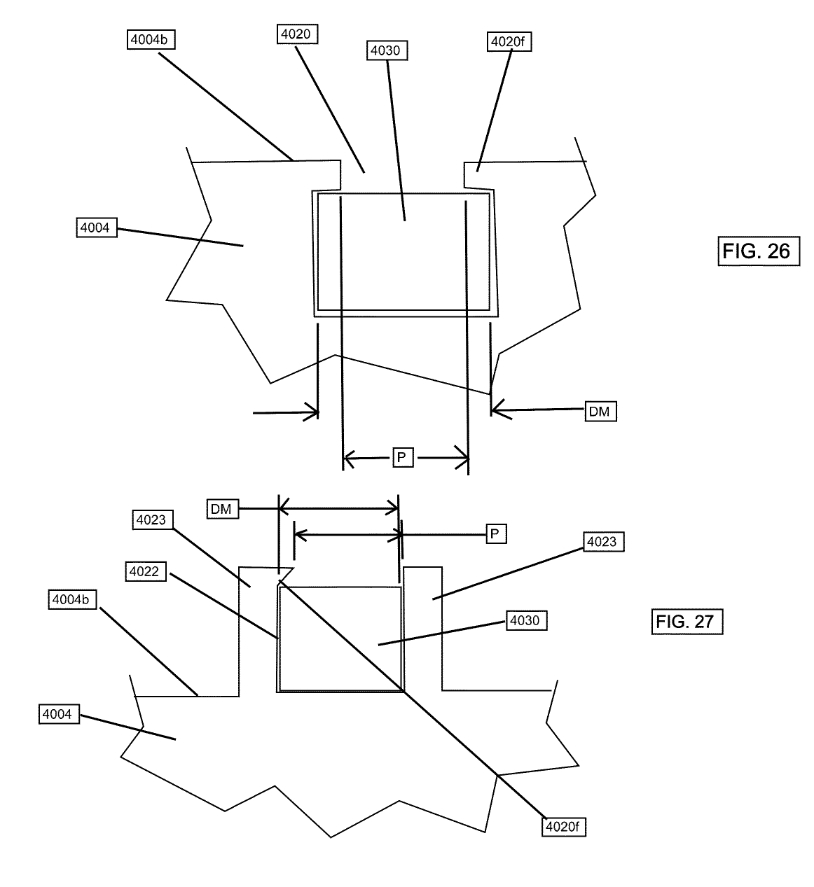

Referring to FIG. 26, in a particular embodiment, a lip or shoulder 4020f extends into the slot from outer face 4004b, along at least one edge of the slot. This shoulder aids in retaining the indicium member 4030 within the slot during use and handling of the marking apparatus, by effectively narrowing the top portion of the slot to a dimension P which is smaller than a diameter or width dimension DM of the indicium member 4030.

In another embodiment shown in FIG. 27, a slot 4022 is formed by a pair of raised shoulders 4023 formed along outer face 4004b and defining the opposite sides of the slot. Referring to FIG. 28, in a particular embodiment, a gap 4024 is formed in an end portion of the shoulder 4023. Gap 4024 is sized to prevent the indicium member 4030 from being forced from the slot through the gap. Gap 4024 provides access to an implement or to a finger of a user to facilitate removal of the indicium member 4030 from the slot, by urging the indicium member 4030 toward the slot open end.

In particular embodiments (for example, in the embodiments shown in FIGS. 5, 12 and 13), a detent 4029 is formed in the slot, which temporarily impedes movement of the indicium member 4030 along the slot during withdrawal and/or insertion of the indicium member. In the embodiments shown, detent 4029 is in the form of a bump projection from one wall of the slot toward the opposite wall of the slot. The embodiment shown in FIGS. 5, 12 and 13 show a pair of oppositely positioned bumps projecting from either side of the slot. However, a single bump may be used. Also, the detent may have any of a variety of other structures suitable for the purposes described herein.

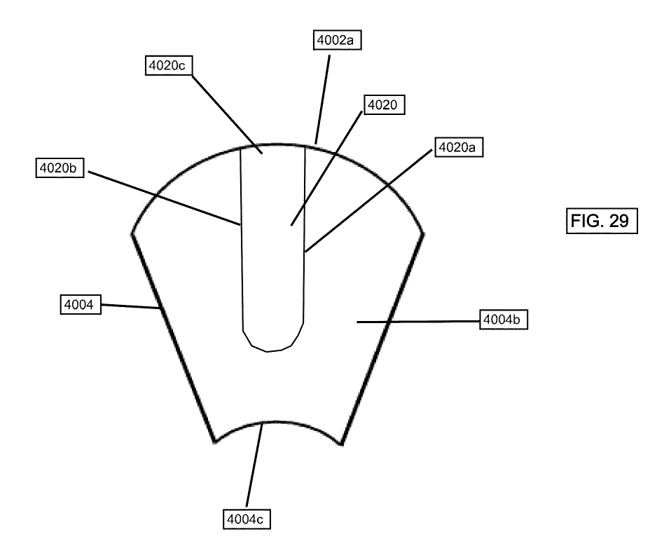

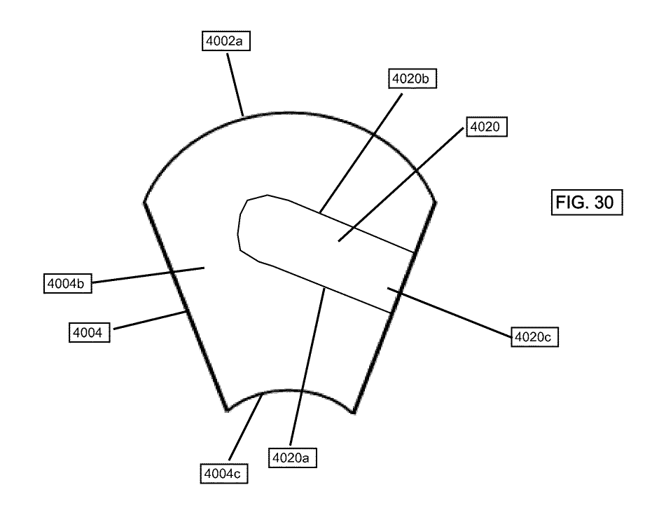

In the embodiments shown in FIGS. 5, 9, 12 and 13, the slot opens in a direction toward the body or main portion of the plate, on which food is placed. In alternative embodiments (FIG. 29, for example), slot 4020 opens in an opposite direction, away from the food placement area of the plate. Referring to FIG. 30, in yet another embodiment, slot 4020 opens in a direction toward a side of the marking apparatus along outer face 4004b.

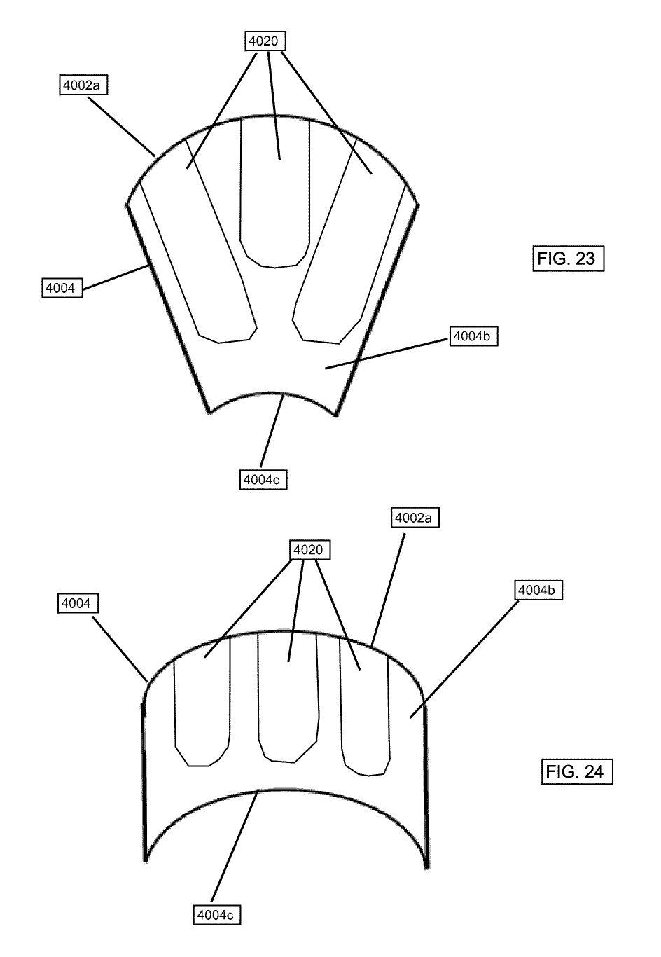

Referring to FIGS. 23-25, in alternative embodiments, multiple slots 4020 are incorporated into the marking apparatus. The provision of multiple slots along first support member outer face 4004b enables multiple indicium members to be attached to this outer face, which enables notification of the presence of multiple associated allergens or food ingredients on the dishware.

In one embodiment, the marking apparatus has six slots formed thereon. However, the surfaces of the marking apparatus may incorporate any desired number of slots, depending on the size and/or configuration of the apparatus, the sizes of the slots, the sizes of the indicium member, and other pertinent factors. In addition, any desired number of slots may be positioned along first support member outer face 4004b, and any desired number of slots may be positioned along second support member outer face 4006b. Provision of multiple slots enables multiple indicium members to be attached to the marking apparatus.

In one embodiment, multiple indicium members 4030 indicating allergen(s) or food ingredient(s) present on the dishware are attached to the first support member outer face 4004b. Each of these indicium members is positioned “face up”, so that the face of the member containing the pertinent information is exposed or visible to a server or customer. Any remaining indicium members may be positioned in associated slots “face down”, or facing the support member, so that the face of the member containing the pertinent information is invisible to a server or customer. In this way, the unused indicium members can be stored on the marking apparatus until needed.

In the embodiment shown in FIG. 23, three slots are positioned along first support member outer face 4004b, and three slots are positioned along second support member outer face 4006b. In this embodiment, the slots splay or fan out in different directions extending in a direction from end edge 4004c toward base outer edge 4002a, with a similar configuration on surface 4006b.

In the embodiment shown in FIGS. 23 and 24, three slots 4020 are positioned along first support member outer face 4004b, and three slots (not visible in FIGS. 23 and 24) are positioned along second support member outer face 4006b. In this embodiment, the slots along any given surface are arranged parallel to each other.

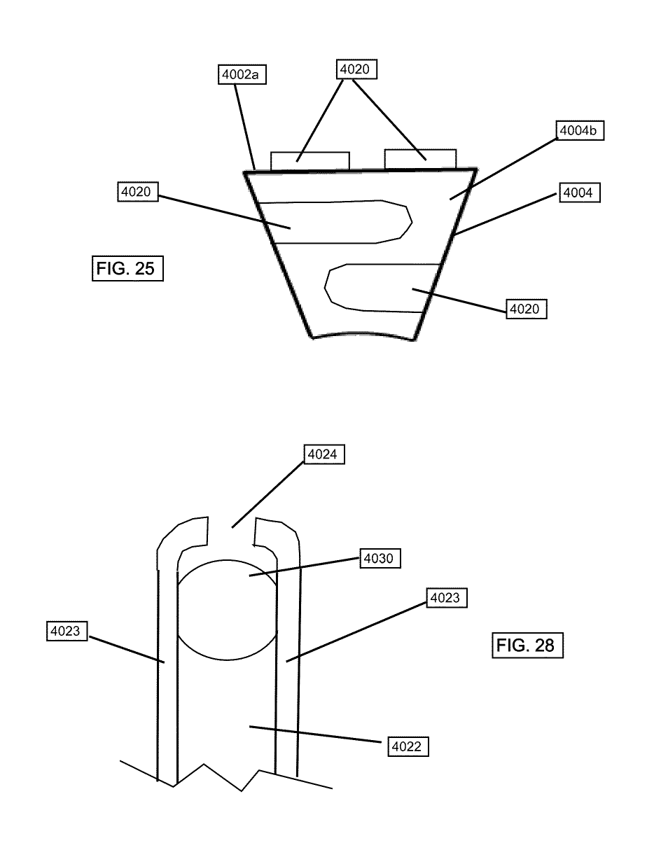

Referring to FIG. 25, in yet another embodiment, slots 4020 open in opposite directions toward respective opposite sides of the marking apparatus.

In the embodiments shown in FIG. 25, slots are positioned along first support member outer face 4004b, and additional slots are positioned along base outer edge 4002a. Any of the slots positioned along the outer edge 4002a may be oriented so as to open either in a direction toward the first support member 4004 or in a direction toward the second support member 4006.

In particular embodiments, the slots along any given surface are arranged parallel to each other.

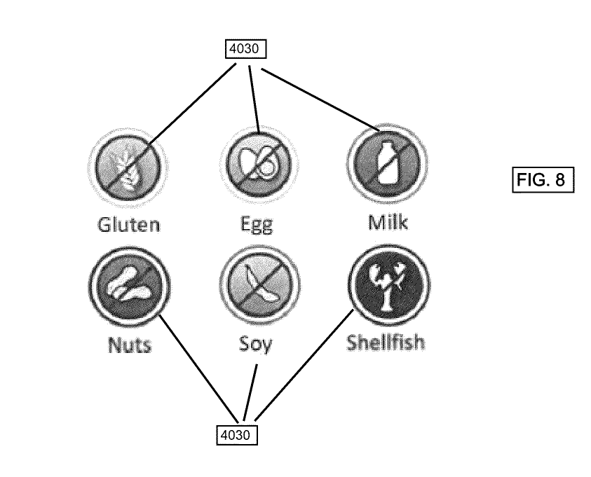

Referring to the drawings, and particularly to FIG. 8, indicium member 4030 has applied or formed thereon an indicium relating to an allergen or ingredient in a food product, as previously described. The indicium member 4030 may have an image, text and/or incorporate or be formed in various different colors, as previously described.

In the embodiments shown in the drawings, indicium member 4030 is circular. However, the indicium member may have any desired alternative shape. In a particular embodiment, indicium member 4030 is 1 inch in diameter. However, the indicium member may have any desired diameter or largest overall dimension, depending on the requirements of a particular application.

FIG. 8 shows several examples of representative indicium members usable in the embodiments described herein. The examples of FIG. 8 are used to indicate that the type of allergen or food ingredient shown on the indicium members are to be omitted or removed from the food placed on the dishware. However, indicium members having other configurations or symbols thereon are also possible.

In the embodiments shown in FIGS. 5-14 and 22, a document retaining slot 4050 is incorporated into marking apparatus base portion 4002 for receiving and retaining a card, slip of paper or other device 4099 containing special food preparation instructions, menu or billing information, or any other desired information relating to the order or to the food product(s) positioned on the dishware, for example.

In the embodiments shown, slot 4050 has a first jaw portion 4050b and a second jaw portion 4050c positioned opposite the first jaw portion. The jaw portions are structured so as to define a cavity 4050d therebetween, for receiving a portion of the document therein. Ends of the jaw portions are structured to contact and grip the document between them. In a particular embodiment, the marking apparatus is structured such that the jaw portions 4050b and 4050c of the retaining slot 4050 is openable by forcing the first and second support members toward each other. In this configuration, the part 4052 of the base portion 4002 residing between cavities 4050d and 4008 functions as a pivot or a hinge about which the first and second support members may be rotated. FIG. 12 shows an example of a document positioned in slot 4050 and secured by jaw portions 4050b and 4050c.

Any or all of the embodiments of base portion 4002, the first support member 4004, and the second support member 4006 may be formed from a heat-resistant material, a “dishwasher-safe” material, a microwavable material, or any other suitable material (for example, a high-temperature polymer) as previously described. Also, in embodiments where the marking apparatus is to be used by a server for handling the dishware without burning the server's fingers, any or all of the base portion 4002, the first support member 4004, and the second support member 4006 may be formed from a thermally-insulative material, for example a silicone.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A marking apparatus for a dishware, the marking apparatus comprising:
a base portion;
a first support member extending from the base portion; and
a second support member extending from the base portion opposite the first support member so as to define a cavity therebetween,
at least one of the first support member and the second support member including at least one slot structured for retaining an indicium member received therein.

2. The marking apparatus of claim 1 further comprising an indicium member positionable in the slot.

3. The marking apparatus of claim 1 wherein the at least one slot is defined by a pair of opposed raised shoulders extending from an outer face of the at least one of the first support member and the second support member.

4. The marking apparatus of claim 1 wherein the first support member has an end edge, and wherein the at least one slot has an open end opening in a direction toward the end edge.

5. The marking apparatus of claim 1 wherein the base portion has an outer edge, and wherein the at least one slot has an open end opening in a direction toward the outer edge.

6. The marking apparatus of claim 1 wherein the first support member has a pair of opposed side edges, and wherein the at least one slot has an open end opening in a direction toward an edge of the pair of side edges.

7. The marking apparatus of claim 1 wherein the base portion includes at least one slot structured for retaining an indicium member received therein.

8. The marking apparatus of claim 1 wherein the base portion includes a document retaining slot formed therein.

9. The marking apparatus of claim 8 wherein the document retaining slot is formed opposite the cavity.

10. A marking apparatus for a dishware, the marking apparatus comprising:
a base portion;
a first support member extending from the base portion, the first support member having a first surface area; and
a second support member extending from the base portion, the second support member having a second surface area, and wherein the second surface area is greater than the first surface area.

11. The marking apparatus of claim 10 wherein a length dimension of the second support member is greater than a length dimension of the first support member.

12. The marking apparatus of claim 10 wherein a width dimension of the second support member is greater than a width dimension of the first support member.

13. The marking apparatus of claim 10 further comprising at least one slot formed in the first support member, the at least one slot being structured for retaining an indicium member therein.

14. The marking apparatus of claim 13 further comprising at least one slot formed in the second support member, the at least one slot being structured for retaining an indicium member therein.

15. The marking apparatus of claim 14 further comprising a plurality of slots formed in the second support member, each slot of the plurality of slots being structured for retaining an indicium member therein.

16. The marking apparatus of claim 13 further comprising a plurality of slots formed in the first support member, each slot of the plurality of slots being structured for retaining an indicium member therein.

17. An apparatus for indicating a feature of a food item located on a food serving implement to which the apparatus is attached, the apparatus comprising:
a base portion;
a support member extending from the base portion;
at least one slot located on the support member; and
an indicium member removably positioned in the at least one slot, the indicium member including an indicium denoting the feature of the food item.
